(19) United States
(12) Patent Application Publication
(10) Pub. No.: US 2007/0248719 A1
(43) Pub. Date: Oct. 25, 2007

(54) Process for producing beer

(75) Inventors: Florian Koch, Nordlingen (DE); Georg Fischer, Deiningen (DE)

Correspondence Address: TRASK BRITT, P.O. BOX 2550, SALT LAKE CITY, UT, 84110, US

(73) Assignee: CARBOTEK HOLDING GMBH, Nordlingen (DE)

(21) Appl. No.: 11/784,520

(22) Filed: Apr. 6, 2007

Related U.S. Application Data
(63) Continuation of application No. PCT/DE06/02063, filed on Nov. 22, 2006.

(30) Foreign Application Priority Data
Nov. 22, 2005 (DE) 10 2005 062 157.0

(51) Int. Cl. C12C 11/00

(52) U.S. Cl. 426/11

(57) ABSTRACT

Described is a process for producing beer, the process having the following steps: a) production of a CO₂-sparse, in particular CO₂-free, beer intermediate; b) racking of the beer intermediate into at least one pressureless or barely pressurizable vessel; and c) adding CO₂ to the beer intermediate in a dispensing facility, as a result of which, the ready-to-consume, CO₂-containing end product beer arises.

### CROSS-REFERENCE TO RELATED APPLICATIONS

This application is a continuation of PCT International Patent Application No. PCT/DE2006/002063, filed on Nov. 22, 2006, designating the United States of America, which application claims priority to German Patent Application Serial No. 10 2005 062 157.0 filed Dec. 22, 2005, the entire contents of each of which are hereby incorporated herein by this reference.

### TECHNICAL FIELD

The present invention relates to a process for producing beer.

### BACKGROUND

Beer is an alcoholic and carbonated beverage. It is produced on the basis of saccharified starch by fermentation. The starch as source material for beer is obtained from grain (barley, rye, wheat, rice, maize), more rarely from potatoes or, for example, peas. According to the German Reinheitsgebot (Purity Regulations), according to which the breweries in Germany predominantly brew, only water, malt, hops, and yeast may be used for the purpose of producing beer. In all cases, alcohol and, in the vernacular, carbonic acid arise in the course of the fermentation process. Stated more precisely, carbon dioxide (CO₂) arises, from which carbonic acid (H₂CO₃) is formed. Over 99% of the carbon dioxide binds only physically in water (or in beer). The remainder (less than 1%) forms, considered chemically, carbonic acid (H₂CO₃).

As used herein, the terms “carbonic acid” or “carbonated” will be used as synonyms for the physicochemical binding of carbon dioxide (CO₂) in water (or in beer) in the specified mixing ratio (99 to 1).

Beer comes onto the market in carbonated form. Without the carbonic acid contained in the beer, beer would be unsuitable for consumption and would be classified as unsatisfactory by food-inspection authorities.

In the course of the brewing process, a distinction is made between primary fermentation and secondary fermentation. In the course of the primary-fermentation process, the carbon dioxide (CO₂) arising escapes as soon as the CO₂ saturation pressure in the liquid has been attained.

In contrast, the carbon dioxide arising in the secondary-fermentation phase is bound in the beer by the fermenting tanks being subjected to a counter-pressure. This is effected, for example, via a bunging apparatus. The latter is an adjustable pressure regulator for the fermentation pressure, for example, 0.5 bar. So long as the internal pressure of the tank is lower than the set counter-pressure, the carbonic acid arising from fermentation is bound in the liquid. CO₂ arising over and above that is able to escape through the bunging apparatus. The amount of bound carbonic acid is temperature-dependent and pressure-dependent.

Due to the carbonic acid bound in the beer, the beer contained in a vessel, for example, a cask or bottle, is under pressure. On average, in the case of bottom-fermented beer, between 4 g and 6 g CO₂ per kg beer is dissolved and, in the case of top-fermented beer, between 4 g and 10 g CO₂ per kg beer. Assuming an average concentration of 6 g/kg, the internal pressure of the vessel at 10° C. amounts to 1.6 bar, and, at 30° C., 3.6 bar. In the course of dispensing, the beer casks, so-called “keg casks,” are filled with CO₂ or another gas with a pressure of up to 3 bar in place of the beer. By reason of the volume of keg casks (typically 20, 30, and 50 liters) and by reason of the maximum pressure (3 bar in the case of beer), the casks are subject to the Druckbehälterverordnung (German pressure-vessel directive) and have to conform to safety requirements.

The greater the volume of the vessels is, the more elaborate the production of the same, since the hazard potential increases with increased volume. Bottles (which are not subject to the Druckbehälterverordnung) are employed in this connection, both in the form of non-returnable bottles and in the form of returnable bottles. Casks, in contrast, are only employed in the form of returnable vessels, since the production process is very elaborate and expensive. A returnable vessel implies re-use and associated return transportation for the purpose of renewed filling. The elaborate manufacture in the case of the cask, the transportation out and back, and also a relatively high empty weight, result in a really high-cost block that, of course, adds to the price of the product.

The filling of a pressure vessel is also relatively elaborate, since the equipment has to satisfy pressure-dependent safety aspects in its structural design. The filling of returnable vessels is likewise expensive, since the vessels have to be intensively cleaned prior to renewed filling.

The demands made upon a dispensing facility are also comparatively stringent, since, here too, both the internal pressure of the cask and the conveying pressure at which the beer is conveyed, make great demands upon the dispensing facility. However, the content of carbonic acid in the beer is absolutely essential. Only carbonic acid that is dissolved in the beer makes the beverage into the beverage as it is understood to be. Beer without, or with little, carbonic acid is simply inconceivable, and would also be unpalatable. Little carbonic acid is the case, by definition, when the lower limit falls short of 4 g CO₂ per kg beer.

### DISCLOSURE OF THE INVENTION

Provided is a process for producing beer available by means of which racking and transportation are facilitated and the total costs, considered from the brewing process up until the dispensing in the dispensing facility, are reduced.

In the process, a CO₂-free or CO₂-sparse beer intermediate is produced. “CO₂-sparse,” also designated as “sparsely CO₂-containing,” means that the content of CO₂ per kg beer amounts to a maximum of 1 g.

This is achieved by, for example, no counter-pressure being applied in the course of the post-fermentation process (so pure atmospheric pressure prevails). In this case, however, up to 3.4 g CO₂ per kg beer are bound. So, in addition, carbonic acid subsequently has to be removed from the beer, for example, by the use of a de-carbonation facility (or “degassing facility”) or by any other known and suitable process by which CO₂ can be removed from a liquid, and which is suitable for food. Further examples of de-carbonation processes are membrane filtration, heating, mechanical motion, expulsion, in particular with N₂ or air, and generation of a vacuum, in particular, by means of a vacuum pump or Venturi tube.

In the case of the intermediate product, it is consequently not a question of a liquid that can be designated as beer but rather a question of a genuine intermediate product that can also be designated as beer initial product. The CO₂ content of this beer intermediate, at a maximum of 1 g per kg beer, lies far below the lowest limit for beer of 4 g CO₂ per kg beer. The beer intermediate would, therefore, be, in itself, unmarketable and unpalatable. The beer intermediate may be a liquid that exhibits a composition and strength like those of standard commercial beer that comes onto the market for consumption, but that is CO₂-free or CO₂-sparse. The beer intermediate may be alcoholic or alcohol-reduced or alcohol-free.

According to the process, this beer intermediate is now racked into at least one vessel, in particular, into a pressureless (also known as “non-pressure”) or barely pressurizable vessel. A vessel is designated as “barely pressurizable” when it withstands up to 0.5 bar excess pressure. Even a quite low content of CO₂ generates an excess pressure in the case of rising temperatures. Therefore, the racking vessel has to withstand certain minimal pressures. Preferably, it does not fall under the Druckbehälterverordnung (German pressure-vessel directive) so that imposed safety conditions, the practical application of which would generate high costs, consequently cease to apply.

The beer intermediate no longer needs to be racked into pressure vessels that are subject to the Druckbehälterverordnung, but may be poured into any arbitrary vessel suitable for food, such as, for example, pressureless casks, containers, etc. The bag-in-box vessels, or even TETRA-PAK® vessels, which have been employed more frequently in recent years for diverse beverages, are also suitable. Beer intermediate produced in this way can consequently be transported in a relatively problem-free manner and without the need for complying with special hazardous-material regulations. Shipping by post or parcel service now also becomes possible.

According to the process, the carbonic acid is added later to the beer intermediate separately, as a result of which, the ready-to-consume end product, beer, is produced. The later adding of the carbonic acid may happen, for example, only in the dispensing facility during dispensing. What is important is that the carbonic acid is dissolved in the beer intermediate. The situation is different in the case of known keg casks, which sometimes provide a CO₂ pressure cushion with the aid of which the beer is conveyed out of the cask. In that case, no additional CO₂ is dissolved in the beer. The beer is already sufficiently carbonized by the carbonic acid arising during fermentation. The CO₂ merely provides the conveying pressure. For this reason, other gases, for example, a CO₂/nitrogen mixture known as Biogon, may also be employed as an alternative to CO₂ in such casks in order to provide the conveying pressure.

The situation is different in the case of the process hereof; what matters here is that carbonic acid is dissolved in a CO₂-free or CO₂-sparse intermediate product, so that only then does beer arise.

### DETAILED DESCRIPTION OF THE INVENTION

A process consequently comprises the following:
(a) producing an at least CO₂-sparse, in particular CO₂-free, beer intermediate,
(b) racking the beer intermediate into at least one vessel, in particular, a pressureless or barely pressurizable vessel, and
(c) subsequent adding of CO₂, taking place outside the brewery, to the beer intermediate, as a result of which, the ready-to-consume end product beer arises.

In such a process, at least one further gas in addition to CO₂ is added to the beer intermediate in step c). Such at least one further gas may be, for example, nitrogen gas. The proportion of the at least one further gas with respect to the gas volume added overall may amount to 0.5 vol. % to 80 vol. %.

The addition of CO₂ and, where appropriate, the at least one further gas in step c) may be carried out with the aid of an impregnator, in particular a carbonator or other suitable equipment. The addition of CO₂ and, where appropriate, the at least one further gas may be effected in an impregnator in which the impregnation with gas, in particular the carbonation, is effected with the aid of an enlarged surface area.

In the process, the beer intermediate may be conveyed out of the vessel, in particular a pressureless or barely pressurizable vessel, with a pump and is supplied to a mixing valve in which CO₂ and, where appropriate, the at least one further gas is/are mixed with the beer intermediate, after which the beer-intermediate/gas mixture enters the impregnator where the binding of CO₂ and the, where appropriate, at least one further gas to the beer intermediate is effected, after which beer intermediate enriched with CO₂ and, where appropriate, at least one further gas leaves the dispensing facility as beer via the tapping cock. In such a process, wherein the beer intermediate may be cooled, in particular in a continuous-flow cooler, prior to reaching the mixing valve and/or with an attendant cooling after leaving the impregnator.

The process may involve racking of the beer intermediate into bag-in-box vessels, pressureless casks, pressureless containers or Tetra-Pak® vessels.

The process may involve the production of CO₂-sparse, in particular CO₂-free, beer intermediate by decarbonation, in particular by membrane filtration, heating, mechanical motion, expulsion, in particular with N₂ or air, or by generation of a vacuum, in particular by means of a vacuum pump or a Venturi tube.

Also described is the use of an impregnator that impregnates a liquid mixed with CO₂ and, where appropriate, at least one further gas by means of a large surface area with the CO₂ and, where appropriate, with the at least one further gas, for, e.g., the purpose of producing beer, wherein a CO₂-sparse, in particular CO₂-free, beer intermediate mixed with CO₂ and, where appropriate, at least one further gas, produced after process step a) of the foregoing process, is passed through the impregnator, as a result of which CO₂ and, where appropriate, at least one further gas is/are bound to the beer intermediate and beer is produced. In such a use, the impregnator may be a bulk-material carbonator, in particular one with quartz granules by way of bulk material, or a solid-matter carbonator.

The advantages of such processes are manifold. The racking costs are lower. The pressure casks (so-called keg casks) to be employed hitherto are expensive to purchase, and their cleaning and racking are technically elaborate and, therefore, also expensive. The logistical costs are reduced, since return transportation is dispensed within the case where disposable packaging is employed. Particularly for fairly small specialty breweries, new sales markets are opened up, since the beer intermediate could also be dispatched by parcel service. Consumer safety is enhanced. In the case of the traditional casks that are used repeatedly, there is a latent danger of contamination. Undetected contaminants contained in the cask may lead to problems upon renewed filling and subsequent consumption. If use is made of non-returnable vessels, such as, for example, bag-in-box systems, such risks do not apply. Safety in the dispensing facility also increases, since only a small part of a dispensing facility in which the carbonation is carried out is under pressure.

The vessel in which the beer intermediate is contained is preferably pressureless or low in pressure. In any case, it is not subject to the Druckbehälterverordnung (German pressure-vessel directive). The situation is contrastingly different in the state of the art, in which the comparatively large pressure casks are under pressure, so that the cask has a very much larger pressurized volume than the carbonator.

Hitherto, it has been simply inconceivable for a brewer to brew a liquid that is designated as a “beer intermediate”: a liquid that, although it corresponds to the known end product, beer, from the point of view of its other constituents and features, does not possess the necessary amount of CO₂. Furthermore, it seemed nonsensical to allow the carbonic acid arising naturally in the course of the fermenting process to escape and, over and above that, even to remove it, in order to add it back later. The inventors, therefore, had to overcome a considerable prejudice in the state of the art in order to arrive at the processes described herein.

In an alternative embodiment of the process, in addition to CO₂, at least one further gas, for example N₂, is added to the beer intermediate. More than one further gas may also be added. The proportion of the at least one further gas with respect to the gas volume added overall amounts to from 0.5 vol. % to 80 vol. %. CO₂ and the at least one further gas may be added simultaneously, for example, in the form of a mixed gas, for example, in the form of a CO₂, N₂ mixture in a ratio of 30/70, or in succession.

Both the adding of CO₂, the so-called carbonation, and the adding of the at least one further gas to the beer intermediate, are preferably effected with the aid of a so-called impregnator, for example, a carbonator for adding CO₂. Use may be made of an impregnator for the purpose, wherein the impregnation is effected with the aid of an enlarged surface area. For the operation of impregnation with such an impregnator, the beer intermediate is mixed with the CO₂ to be added and, where appropriate, with at least one further gas, and is supplied to the impregnator. The mixture consisting of CO₂, where appropriate, at least one further gas, and beer intermediate is conducted there through a system full of baffles and deflections. By virtue of the many baffles and deflections, a large surface area is made available, and the mixture is always broken through anew and agitated locally, so that the CO₂ and, where appropriate, the at least one further gas, is/are bound in the beer intermediate. The use of an impregnator with a large surface area is particularly advantageous, since by this means, a finely effervescent distribution of the carbonic acid and, where appropriate, of the at least one further gas in the beer intermediate and hence in the end product, beer, is made possible. Furthermore, a foaming of the beer intermediate during the impregnation operation is prevented as far as possible, or is greatly reduced. An impregnator that is suitable for use in the implementation of the present invention is, for example, a bulk-material carbonator as disclosed in DE 101 60 397 A1, or a solid-matter impregnator as described in DE 10 2006 014 814, the contents of which are incorporated herein by this reference in their entirety.

Trials have shown that the beer produced in accordance with the processes described herein does not differ, either from the point of view of taste or from the point of view of consistency or optical characteristics, from beer that has been produced in accordance with the process of the state of the art.

According to a further aspect of the process, the use of an impregnator for producing beer is provided. In the case of the impregnator that is used, it is a question of one in which the impregnation of a liquid mixed with CO₂ and, where appropriate, at least one further gas is achieved by virtue of a large surface area, for example, as described in DE 101 60 397 A1 or in DE 10 2006 014 814. In the course of use, a CO₂-free or CO₂-sparse beer intermediate mixed with CO₂ and, where appropriate, with at least one further gas, which has been produced after process step a) of the process hereof, is passed through the impregnator. As a result of this, the CO₂ and, where appropriate, the at least one further gas, is/are bound to the beer intermediate which, as a result, leaves the impregnator as beer. A large surface area in the impregnator may be achieved by means of quartz granules or by means of a porous material, in particular, a sintered, woven, fibrous or foamed material.

The following Table 1 reproduces a flow chart of the production process in schematic representation.

TABLE 1
Production Process

| Stage | Device/Facility | Product State Start | Process Step | Product State End |
|---|---|---|---|---|
| 1a | Storage tank/ | Wort after primary | Secondary | Unfiltered beer |
| | CCF (cylindro- | fermentation | fermentation with tank | about 5 g CO₂/kg |
| | conical | | counter-pressure. | beer |
| | fermenting | | Duration about 4-6 | |
| | tank) | | weeks. | |
| 1b | Storage tank/ | Wort after primary | Secondary | Beer intermediate, |
| | CCF | fermentation | fermentation without | unfiltered about |
| | | | tank counter-pressure. | 3.4 g CO₂/kg beer |
| | | | Duration about 4-6 | |
| | | | weeks. | |
| 2a | Filter | Unfiltered beer | Filtration | Filtered beer about |
| | | about 5 g CO₂/kg | | 5 g CO₂/kg beer |
| | | beer | | |
| 2b | Filter | Beer intermediate, | Filtration | Beer intermediate, |
| | | unfiltered about | | filtered about 3.4 g |
| | | 3.4 g CO₂/kg beer | | CO₂/kg beer |
| 3 | Decarbonator | Filtered beer (2a | Removal of surplus | Beer intermediate, |
| | | end) or beer | CO₂ content until | filtered with little/ |
| | | intermediate (2b | defined final | hardly any CO₂ |
| | | end) | concentration CO₂ | (CO₂-sparse or |
| | | | obtains. | CO₂-free) |
| 4 | Flash heater | Beer intermediate, | Flash-heater | Racked beer |
| | and racking | filtered with little/ | pasteurization and | intermediate, |
| | facility | hardly any CO₂ | subsequent racking | filtered with |
| | | (CO₂-sparse or | into pressureless or | little/hardly any |
| | | CO₂-free) | barely pressurizable | CO₂. Keeps in the |
| | | | vessel. | brewery. |
| 5 | Sale/ | Racked beer | Sale of the product and | Racked beer |
| | transportation | intermediate, filtered | transportation to the | intermediate, |
| | | with little/hardly any | customer | filtered with |
| | | CO₂. Keeps in the | | little/hardly any |
| | | brewery. | | CO₂. At customer's |
| | | | | premises. |
| 6 | Dispensing | Racked beer | Tapping and | Finished beer in the |
| | facility with | intermediate, filtered | carbonating of the beer | glass of the |
| | impregnator | with little/hardly any | intermediate with CO₂. | consumer |
| | (carbonator) | CO₂. At customer's | | |
| | | premises. | | |

The schematic representation describes, in stepwise manner, the changed process for producing the beer. Column One contains the step number. In the second column, the stage-typical devices/facilities are defined. The third column describes the state of the product at the start of the stage, the next column elucidates the process-engineering operations, and the final column reproduces the stage-typical end state of the product.

Stage 1: Secondary fermentation. The changed production begins with the secondary fermentation. Either this takes place quite conventionally with tank counter-pressure (1a), or alternatively the secondary fermentation takes place without tank counter-pressure (1b). The result is, in the case of (1a), an unfiltered beer with finished carbonic-acid content (about 5-6 g CO₂ per kg beer), or, in the case of (1b), an unfiltered beer intermediate with about 3.4 g CO₂ per kg beer. In accordance with the physical binding properties of CO₂, this results in beer without counter-pressure at about 0° C.

Stage 2: Filtration. Filtration takes place, but not with all beers. It serves for removing sludge particles and yeast cells. The reason is the desire of the consumer for a clear, bright product. The result is, in the case of (2a), a filtered beer, or, in the case of (2b), a filtered beer intermediate with, in each instance, unchanged contents of CO₂.

Stage 3: Decarbonation. Irrespective of whether the secondary fermentation (Stage 1) proceeded after (1a) or (1b), or whether the filtration (Stage 2) proceeded after (2a) or (2b), the CO₂ content now has to be removed, except for a maximum of 1 g CO₂ per kg beer. This amount results from the permissible/tolerable maximum pressure of the racking vessels (in the case of a bag-in-box vessel, a maximum of 0.5 bar). Also at high temperatures of up to 80° C., this pressure must not be attained. The result of the decarbonation is a CO₂-sparse or even virtually CO₂-free beer intermediate (in the case of filtration, filtered; otherwise unfiltered).

Alternatively provided also is a decarbonation with subsequent filtration. (Interchange of Stages 2 and 3.) The result after Stage 3 would always be a CO₂-sparse or even virtually CO₂-free beer intermediate.

Stage 4: Racking. For reasons of shelf-life, the beer intermediate, irrespective of whether filtered or not, will be pasteurized with the aid of a flash heater immediately prior to racking. The beer intermediate is subsequently charged into a suitable vessel (for example, a bag-in-box). Because of the low maximum pressure, the vessel is not subject to the Druckbehälterverordnung (German pressure-vessel directive). The result is a racked beer intermediate, which is still located at the brewery.

Stage 5: Sale/Transportation. The racked beer intermediate is now sold by the brewery and transported to the customer. This can also be undertaken, for example, by parcel service. The result is a racked beer intermediate, which is ultimately located at the customer's premises.

Stage 6: Retailing with impregnation, in particular, carbonation. At this stage, by addition of CO₂, the finished end product, beer, is generated from the beer intermediate. What is important is that the carbonic acid is bound in the beer. The end product cannot be distinguished from beer that has been produced and marketed classically. The result of this stage is a finished, freshly tapped beer in the glass of the consumer. According to an alternative embodiment, the beer intermediate may, in addition to the impregnation with CO₂, be impregnated with at least one further gas.

The following flow chart shows a first embodiment of a schematic structure of a dispensing facility (operation during Table 1/Stage 6).
1. [Racked beer intermediate keeps at the customer's premises in the cellar or cold store]
   ⇓
2. Continuous-flow cooler (if present)
   ⇓
3. Pump
   ⇓
   ⇓ ______ 4. CO₂ bottle
   ⇓ ⇓
5. Mixing valve
   ⇓
6. [Beer-intermediate/CO₂ mixture]
   ⇓
7. Carbonator
   ⇓
8. Spiral
   ⇓
9. Attendant cooling (if present)
   ⇓
10. Tapping cock
   ⇓
11. [Finished beer in the glass]
   4. Racked Beer Intermediate at the Customer's Premises

The racked beer intermediate is stored at the customer's premises, preferentially in a cold store. The beer intermediate is contained in a vessel that is not subject to the Druckbehälterverordnung (German pressure-vessel directive), for example, a bag-in-box vessel. Typically, the vessel is stored where the keg casks (according to the current state of the art) are also stored.

5. Continuous-Flow Cooler

The beer intermediate still is cooled, particularly when it is not being stored in a cold store. For this purpose, use may be made of a conventional continuous-flow cooler, which is frequently already present.

6. Pump

The pump aspirates the beer intermediate out of the vessel through the continuous-flow cooler and subsequently presses it through the rest of the dispensing facility. Alternatively, the pump may also be fitted upstream of the continuous-flow cooler (2). In this case, the beer intermediate is then already pressed through the continuous-flow cooler and is not aspirated. For the purpose of conveying the beer intermediate, a membrane pump, for example, may be employed, which can be driven by CO₂ from the CO₂ bottle (4). Alternatively, compressed air may also be employed. With the aid of the pump, not only is the beer intermediate supplied to the mixing valve (5), but the beer intermediate and, in the further course, the beer-intermediate/CO₂ mixture (6) are conveyed through the entire facility as far as the tapping cock. The conveying pressure at the exit of the pump may amount to 6 bar, for example. By virtue of this comparatively high conveying pressure, the absorption of CO₂ in the carbonator (7) is favored.

7. CO₂ Bottle

The CO₂ bottle has the task of supplying the CO₂ for the purpose of carbonating the beer intermediate. It may also be used additionally for the purpose of driving the pump.

8. Mixing Valve

Here, the beer intermediate and the carbonic acid from the CO₂ bottle come together. However, binding takes place only later in the carbonator (7). Preferred is a final concentration of the CO₂ in the end product, beer (11), of 5-7 g CO₂ per kg beer. The CO₂ pressure for admixing the CO₂ to the beer intermediate must be higher than the conveying pressure of the beer intermediate, which is generated by the pump (3). A pressure difference of about 0.2 bar has proved favorable in trials. At a conveying pressure of 6 bar, the CO₂ pressure consequently amounts to 6.2 bar. By reason of the pressure difference between CO₂ pressure and conveying pressure, a mixing of CO₂ and beer intermediate in the mixing valve is made possible. The mixing valve exhibits a fine nozzle, through which the CO₂ gas flows in. If the tapping cock of the dispensing facility (10) is actuated and liquid (or rather, beer) is withdrawn, then, by reason of this fine nozzle, a fall in CO₂ pressure occurs in the mixing valve. The fine nozzle prevents a sudden, “unlimited” after-flow of CO₂. In the mixing valve, the CO₂ pressure consequently falls below the conveying pressure of the beer intermediate. Hence, liquid flows into the mixing valve, so that a mixing with the CO₂ gas now occurs.

9. Beer-Intermediate/CO₂ Mixture

The mixture consisting of the beer intermediate and the supplied carbonic acid flows into the impregnator, here into the carbonator (7).

10. Carbonator

The beer-intermediate/CO₂ mixture (6) is supplied to the impregnator. As explained above, an impregnator with a large surface area is preferably employed, for example, a bulk-material carbonator or solid-matter impregnator, on which the carbonic acid is able to combine with the beer intermediate. After passing through the impregnator, the carbonic acid has mixed with the beer intermediate and is bound to it. Consequently, beer leaves the impregnator.

11. Spiral

The beer enters a spiral, where the reduction in pressure is effected. As specified above, the conveying pressure is comparatively high (about 6 bar). In dispensing facilities, however, a pressure from 2 bar to 2.5 bar typically prevails. The reduction in pressure is performed with the aid of a spiral having a variable number of turns.

12. Attendant Cooling

An attendant cooling is optionally provided in order to prevent a warming of the beer on the way to the tapping cock. The necessity for attendant cooling depends on the on-site circumstances.

13. Tapping Cock

The beer is now supplied to the tapping cock of the dispensing plant. In the tapping cock, a so-called compensator is ordinarily provided, with which the pipe pressure is reduced.

14. Finished End Product in the Glass

A freshly tapped beer as finished end product flows out of the tapping cock into the glass of the consumer.

In the following, a flow chart shows a further design of a dispensing facility (schematic structure) (operation during Table 1/Stage 6).
1. [Racked beer intermediate keeps at the customer's premises in the cellar or cold store]
   ⇓
2. Continuous-flow cooler (if present)
   ⇓
3. Pump
   ⇓
   ⇓ ______ 4a. CO₂ bottle
   ⇓ ⇓ ______ 4b. N₂ bottle
      ⇓
5. Mixing valve
   ⇓
6. [Beer-intermediate/CO₂/N₂ mixture]
   ⇓
7. Impregnator
   ⇓
8. Compensator
   ⇓
9. Attendant cooling (if present)
   ⇓
10. Tapping cock
   ⇓
11. [Finished beer in the glass]

For more detailed elucidation, reference is made at like parts to the description above.

4. CO₂ Bottle (4a) and N₂ Bottle (4b)

The CO₂ bottle has the task of supplying the CO₂ for the purpose of carbonating the beer intermediate. It may also be used additionally for the purpose of driving the pump. In the N₂ bottle, nitrogen is stored by way of further gas. Alternatively, CO₂ and nitrogen may also be provided by way of finished mixture in the desired mixing ratio and may be made available in a single bottle. As an example here, Biogon may be cited (CO₂/ N₂=30/70).

5. Mixing Valve

Here, the beer intermediate, the carbonic acid from the CO₂ bottle, and the nitrogen from the N₂ bottle come together. However, a binding takes place only later in the impregnator (7). With regard to further details, reference is made to the description above.

6. Beer-Intermediate/CO₂/N₂ Mixture

The mixture consisting of the beer intermediate, the supplied carbonic acid and the supplied nitrogen flows into the impregnator (7).

7. Impregnator

The beer-intermediate/CO₂/N₂ mixture (6) is supplied to the impregnator. After passing through the impregnator, the carbonic acid and the nitrogen have mixed with the beer intermediate and are bound to it. Consequently, beer mixed with nitrogen leaves the impregnator.

8. Compensator

Instead of a spiral, in this design a compensator is provided, in order to achieve a reduction in pressure. Attention is drawn to the fact that, both in this exemplary embodiment and in that above, any suitable means may be employed with which a reduction in pressure can be implemented. The spiral and the compensator are examples of such means.

1. A process for producing beer, said process comprising:
a) producing a CO₂-sparse or CO₂-free beer intermediate,
b) racking the beer intermediate into at least one pressureless or barely pressurizable vessel, and
c) adding CO₂ to the beer intermediate in a dispensing facility, as a result of which ready-to-consume, CO₂-containing end product, beer, arises.

2. The process according to claim 1, further comprising adding, in c), at least one further gas in addition to CO₂ to the beer intermediate.

3. The process according to claim 2, wherein N₂ is added in addition to CO₂.

4. The process according to claim 2, wherein the proportion of the at least one further gas with respect to the gas volume added overall amounts to 0.5 vol. % to 80 vol. %.

5. The process according to claim 3, wherein the proportion of the at least one further gas with respect to the gas volume added overall amounts to 0.5 vol. % to 80 vol. %.

6. The process according to claim 1, wherein adding CO₂ to the beer intermediate utilizes an impregnator or a carbonator.

7. The process according to claim 5, wherein the impregnator utilizes an enlarged surface area.

8. The process according to claim 1, wherein the beer intermediate is conveyed out of the vessel with a pump and is supplied to a mixing valve in which CO₂ and any at least one further gas is/are mixed with the beer intermediate, after which the beer-intermediate/gas mixture enters the impregnator where the binding of CO₂ and any at least one further gas to the beer intermediate is effected, after which beer intermediate enriched with CO₂ and any at least one further gas leaves a dispensing facility as beer via the tapping cock.

9. The process according to claim 8, wherein the beer intermediate is cooled prior to reaching the mixing valve and/or with an attendant cooling after leaving the impregnator.

10. The process according to claim 1, further comprising racking the beer intermediate into bag-in-box vessels, pressureless casks, pressureless containers and/or Tetra-Pak® vessels.

11. The process according to claim 1, wherein the production of the CO₂-sparse, in particular CO₂-free, beer intermediate is effected by de-carbonation

12. The process according to claim 11, wherein the decarbonation is effected by de-carbonation by membrane filtration, heating, mechanical motion, expulsion, in particular with N₂ or air, or by generation of a vacuum, in particular by means of a vacuum pump or a Venturi tube.

13. The method according to claim 1, further comprising, after process step a), using an impregnator to impregnate a liquid mixed with CO₂ and any at least one further gas by means of a large surface area with the CO₂ and any at least one further gas, so as to produce beer, wherein a CO₂-sparse or CO₂-free, beer intermediate mixed with CO₂ and, where appropriate, at least one further gas, produced is passed through the impregnator, as a result of which CO₂ and any at least one further gas is/are bound to the beer intermediate and beer is produced.

14. The method according to claim 13, wherein the impregnator is a bulk-material carbonator or a solid-matter carbonator.

15. A CO₂-sparse or CO₂-free beer intermediate.
